(19) United States
(12) Patent Application Publication
(10) Pub. No.: US 2022/0126791 A1
(43) Pub. Date: Apr. 28, 2022

(54) SENSOR SURFACE CLEANING APPARATUS FOR VEHICLE

(71) Applicant: TOYOTA JIDOSHA KABUSHIKI KAISHA, Toyota-shi (JP)

(72) Inventors: Ryusuke SHIMIZU, Toyota-shi (JP); Yuhei OKA, Toyota-shi (JP)

(73) Assignee: TOYOTA JIDOSHA KABUSHIKI KAISHA, Toyota-shi (JP)

(21) Appl. No.: 17/506,929

(22) Filed: Oct. 21, 2021

(30) Foreign Application Priority Data
Oct. 26, 2020 (JP) 2020-178680

(51) Int. Cl. B60S 1/56; B60S 1/48; B08B 3/02; B08B 13/00; G01S 7/497

(52) U.S. Cl. CPC B60S 1/56; B60S 1/481; G01S 2007/4977; B08B 13/00; G01S 7/497; B08B 3/02

(57) ABSTRACT

A sensor surface cleaning apparatus for a vehicle includes at least one sensor or camera, at least one cleaning unit for jetting a cleaning liquid toward a sensor surface of the sensor or camera, and a travel control ECU which operates in accordance with its operation mode switchable between a first mode in which automatic cleaning operation is permitted and a second mode in which the automatic cleaning operation is not permitted. In a period during which the operation mode is the first mode, the travel control ECU switches the operation mode to the second mode upon satisfaction of at least one of a first particular condition showing an environment in which the sensor surface easily becomes dirty and a second particular condition showing that dirt on the sensor surface cannot be removed by the cleaning liquid.

### BACKGROUND OF THE INVENTION

### Field of the Invention

The present invention relates to a sensor surface cleaning apparatus for a vehicle.

### Description of the Related Art

Japanese Patent Application Laid-Open (kokai) No. 2019-104365 discloses a cleaning system for a vehicle. The cleaning system includes a plurality of cleaning units which clean, by using a cleaning liquid, cleaning targets, including a sensor surface of an optical sensor mounted on the vehicle, and a control unit which controls the cleaning units. When cleaning requests to the cleaning units are issued, the control unit activates the cleaning units in accordance with the order of priority determined on the basis of traveling conditions of the vehicle and/or environmental conditions. Notably, the term “sensor surface” refers to a surface of a lens of an optical sensor, a surface of a transparent cover of an optical sensor, or a surface of a portion formed of, for example, glass and through which an optical sensor receives light, the surfaces being exposed to the outside of the vehicle. The cleaning system for a vehicle disclosed in Japanese Patent Application Laid-Open No. 2019-104365 can clean the cleaning targets sequentially in accordance with the order of priority.

Incidentally, when a vehicle is travelling in an environment in which dirt easily adheres to a sensor surface, the frequency of operation of a cleaning unit for the sensor surface increases, and the amount of a cleaning liquid used increases. Also, in the case where dirt has strongly adhered to the sensor surface and the adhered dirt cannot be removed by operating the cleaning unit one time, the operation of the cleaning unit is repeated within a short period of time. In such a case as well, the amount of the cleaning liquid used increases.

### SUMMARY OF THE INVENTION

The present invention has been accomplished so as to solve the above-described problem, and one object of the present invention is to provide a sensor surface cleaning apparatus for a vehicle which cleans the sensor surface of a sensor by using a cleaning liquid and which reduces the amount of the cleaning liquid used.

In order to solve the above-described problem, a sensor surface cleaning apparatus (100) for a vehicle (10) according to the present invention includes:

a sensor unit (101, 102, 103, 104) which produces output data by using an electromagnetic wave passing through a window portion whose one surface is exposed to an environment outside the vehicle as a sensor surface;

a cleaning unit (106, 107, 108, 109) configured to clean the sensor surface by using a cleaning liquid; and

a control unit (114) which determines whether or not an automatic cleaning condition has been satisfied, the automatic cleaning condition being determined beforehand such that the automatic cleaning condition is satisfied when the sensor surface is dirty to an extent that requires cleaning, the control unit causing the cleaning unit to perform automatic cleaning operation which uses a predetermined amount of the cleaning liquid, when the control unit determines that the automatic cleaning condition has been satisfied.

The control unit (114) is configured to operate in accordance with an operation mode switchable between a first mode in which the control unit permits the automatic cleaning operation and a second mode in which the control unit does not permit the automatic cleaning operation.

The control unit (114) is configured in such a manner that, in a case where the operation mode is the first mode, the control unit determines whether or not a cleaning prohibition condition has been satisfied, the cleaning prohibition condition being determined beforehand such that the cleaning prohibition condition is satisfied when a frequency of execution of the automatic cleaning operation exceeds a limit frequency, and the control unit switches the operation mode to the second mode (step S108) upon determination that the cleaning prohibition condition has been satisfied (step S105: Yes; step S106: Yes).

The control unit (114) may be configured to obtain, on the basis of the output data from the sensor unit (101, 102, 103, 104), a sensor surface dirtiness index value representing a degree of dirtiness of the sensor surface, to determine whether or not the sensor surface dirtiness index value is equal to or greater than a first threshold (step S101), and to determine that the automatic cleaning condition has been satisfied when the control unit determines that the sensor surface dirtiness index value is equal to or greater than the first threshold (step S101: Yes).

The control unit (114) may be configured to determine that the cleaning prohibition condition has been satisfied when the control unit determines that a predetermined first particular condition showing that a travel environment of the vehicle (10) is an environment in which the sensor surface easily becomes dirty has been satisfied (step S105: Yes).

The control unit (114) may be configured to determine that the first particular condition has been satisfied (step S105: Yes) when the number of times the control unit has caused the cleaning unit (106, 107, 108, 109) to perform the automatic cleaning operation during a period of time during which the vehicle (10) has traveled over a predetermined distance is equal to or greater than a second threshold.

The control unit (114) may be configured to determine that the cleaning prohibition condition has been satisfied when the control unit determines that a predetermined second particular condition showing that dirt on the sensor surface cannot be removed by the cleaning liquid jetted by the cleaning unit (106, 107, 108, 109) has been satisfied (step S106: Yes).

The control unit (114) may be configured to determine that the second particular condition has been satisfied (step S106: Yes) when the number of times of continuous operation is equal to or greater than a third threshold, the number of times of continuous operation being the number of times of continuous occurrence of a phenomenon in which a time between a point when the automatic cleaning operation ends and a point when the automatic cleaning operation is started again upon new determination that the automatic cleaning condition has been satisfied is shorter than a predetermined threshold time.

According to the present invention, the control unit (114) does not activate the cleaning unit (106, 107, 108, 109) in the case where the vehicle (10) is traveling in an environment in which the sensor surface easily becomes dirty or in the case where removal of dirt on the sensor surface through operation of the cleaning unit (106, 107, 108, 109) is difficult. Therefore, the amount of the cleaning liquid used can be reduced.

The control unit (114) may be configured to change the operation mode from the second mode to the first mode (step S104) when an ignition switch (111) of the vehicle (10) is turned off in a period during which the operation mode is the second mode.

The control unit (114) may be configured to change the operation mode from the second mode to the first mode (step S104) when the control unit determines that the sensor surface dirtiness index value is continuously equal to or less than a cancellation threshold less than the first threshold for a predetermined time in a period during which the operation mode is the second mode.

By virtue of these configurations, it is possible to clean the sensor surface when the predetermined cancellation condition has been satisfied, while reducing the amount of the cleaning liquid used.

The control unit (114) may be configured in such a manner that, in the case where the control unit has changed the operation mode from the first mode to the second mode (step S108), the control unit executes notification control of notifying an occupant of the vehicle that the automatic cleaning operation is not performed (step S109).

By virtue of such a configuration, it is possible to urge an occupant to clean the sensor surface manually (namely, without using the cleaning unit (106, 107, 108, 109), or it is possible to urge the occupant to move the vehicle (10) to an environment in which the sensor surface is less likely to become dirty. In addition, it is possible to prevent the occupant from feeling discomfort about the fact that the cleaning unit (106, 107, 108, 109) does not operate.

In the above description, in order to facilitate understanding of the present invention, the constituent elements of the invention corresponding to those of an embodiment of the invention which will be described later are accompanied by parenthesized names and/or symbols which are used in the embodiment; however, the constituent elements of the invention are not limited to those in the embodiment defined by the names and/or symbols.

### BRIEF DESCRIPTION OF THE DRAWINGS

FIG. 1 is a diagram showing the configuration of a vehicle; and

FIG. 2 is a flowchart showing a routine executed by a CPU.

### DESCRIPTION OF THE PREFERRED EMBODIMENT

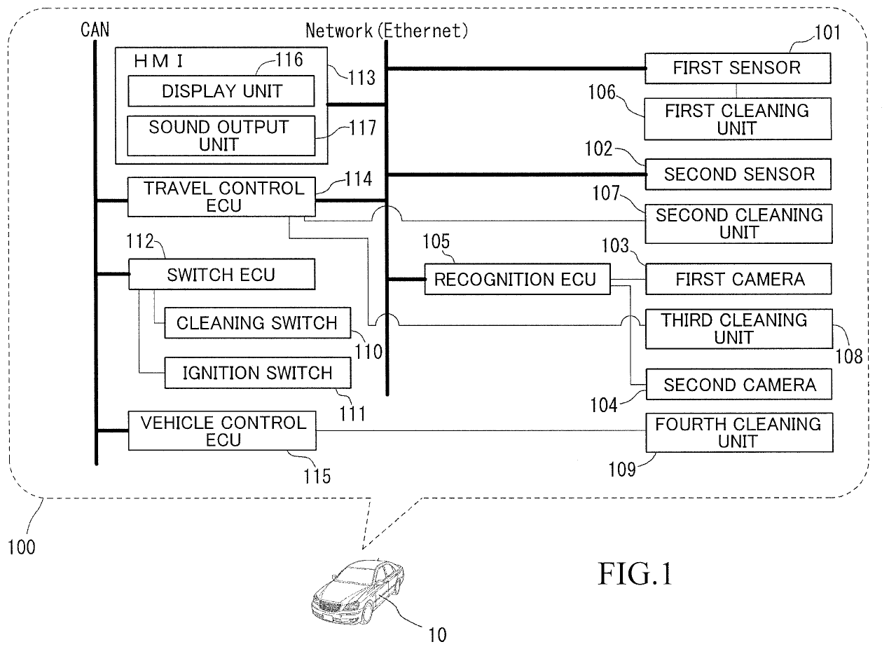

A sensor surface cleaning apparatus 100 for a vehicle according to an embodiment of the present invention will now be described. As shown in FIG. 1, this sensor surface cleaning apparatus 100 is mounted on a vehicle 10. The sensor surface cleaning apparatus 100 includes a first sensor 101, a second sensor 102, a first camera 103, a second camera 104, a recognition ECU 105, a first cleaning unit 106, a second cleaning unit 107, a third cleaning unit 108, a fourth cleaning unit 109, a cleaning switch 110, an ignition switch 111, a switch ECU 112, an HMI 113, a travel control ECU 114, and a vehicle control ECU 115.

Each of the recognition ECU 105, the switch ECU 112, the travel control ECU 114, and the vehicle control ECU 115 has a computer including a CPU, a ROM, a RAM, an interface, etc. Notably, the “ECU” means an “electronic control unit” and may be called a control unit or a controller.

The switch ECU 112, the travel control ECU 114, and the vehicle control ECU 115 are connected together trough a CAN (Controller Area Network) in such a manner that signals can be transmitted and received among the ECUs 112, 114, and 115. The first sensor 101, the second sensor 102, the recognition ECU 105, the HMI 113, and the travel control ECU 114 are connected together trough an Ethernet network in such a manner that signals can be transmitted and received among the first sensor 101, the second sensor 102, the recognition ECU 105, the HMI 113, and the travel control ECU 114. Notably, all or some of the recognition ECU 105, the switch ECU 112, the travel control ECU 114, and the vehicle control ECU 115 may be integrated into a single ECU. Alternatively, these ECUs may be replaced with five or more ECUs.

Each of the first sensor 101 and the second sensor 102 is a LIDAR (LIDAR stands for Light Detection and Ranging or Laser Imaging Detection and Ranging). The LIDAR emits, for example, infrared laser light in the form of pulses and measures a time which elapses until reflection light produced as a result of refection of the emitted laser light by an object reaches the LIDAR. The LIDAR measures the distance between the LIDAR and the object on the basis of the measured time. The LIDAR emits a narrowed beam of the infrared laser light in various directions by using a movable mirror. As a result, the LIDAR can also detects the direction of the object.

Each of the first sensor 101 and the second sensor 102 has a window portion (protective portion) which allows passage of the laser light therethrough, and determines the distance to the object and the direction of the object by using the laser light passing through the window portion. Each of the first sensor 101 and the second sensor 102 is attached to the vehicle in such a manner that one surface of the window portion is exposed to an environment outside the vehicle 10 (hereinafter may be referred to as the “outside of the vehicle 10”). The surface of the window portion exposed to the outside of the vehicle will be referred to as the “sensor surface.” In order to maintain high sensor measuring accuracy, the sensor surface is preferably maintained in a state (clean state) in which deposits such as dust and mud are not present on the sensor surface.

The first sensor 101 is provided in a central portion (in a vehicle width direction) of the front grille of the vehicle 10 and is configured to emit laser light toward the front side of the vehicle 10. Accordingly, the first sensor 101 can determine, for example, the distance between the first sensor 101 and an object present ahead of the vehicle 10 (namely, a moving object such as another vehicle or a pedestrian or a stationary object) and the direction of the object in relation to the first sensor 101.

The second sensor 102 is provided on a side surface of the vehicle 10 and is configured to emit laser light toward the outer side in the vehicle width direction (for example, the right side of the vehicle). The second sensor 102 can determine, for example, the distance between the second sensor 102 and an object present at the side (for example, on the right side) of the vehicle 10 and the direction of the object in relation to the second sensor 102. Notably, the second sensor 102 may include a left-side second sensor disposed on the left side surface of the vehicle so as to perform measurement for an object present on the left side of the vehicle and a right-side second sensor disposed on the right side surface of the vehicle so as to perform measurement for an object present on the right side of the vehicle.

Each of the first camera 103 and the second camera 104 is a camera which obtains an image (produces image data) by photographing a scene around the vehicle 10 by using visible light.

The first camera 103 is provided in the interior of the vehicle 10 to be located at a central portion (in the vehicle width direction) of an upper portion of a front windshield glass (hereinafter referred to as the “front glass”). The first camera 103 is configured to photograph a scene ahead of the vehicle 10 by using visible light passing through a portion of the front glass, which portion is located in front of the lens of the first camera 103 (hereinafter, that portion is referred to also as the “front photographing window portion”). One surface of the front photographing window portion is exposed to the outside of the vehicle. Accordingly, the one surface of the front photographing window portion is also referred to as the sensor surface. As described above, it is desired that the sensor surface be maintained in a clean state. Notably, the first camera 103 may be provided in a central portion (in the vehicle width direction) of the front grille of the vehicle 10. The first camera 103 has a window portion (protective portion) through which the visible light for obtaining an image passes, and one surface of the window portion is exposed to the outside of the vehicle. Accordingly, the one surface of this window portion is also referred to as the sensor surface.

The second camera 104 is provided in the interior of the vehicle 10 to be located at a central portion (in the vehicle width direction) of an upper portion of a rear windshield glass (hereinafter referred to as the “rear glass”). The second camera 104 is configured to photograph a scene behind the vehicle 10 by using visible light passing through a portion of the rear glass, which portion is located in front of the lens of the second camera 104 (namely, located on a side of the lens toward the rear of the vehicle) (hereinafter, that portion is referred to also as the “rear photographing window portion”). One surface of the rear photographing window portion is exposed to the outside of the vehicle. Accordingly, the one surface of the rear photographing window portion is also referred to as the sensor surface. As described above, it is desired that the sensor surface be maintained in a clean state.

As described above, each of the first sensor 101, the second sensor 102, the first camera 103, and the second camera 104 substantially has the “sensor surface which is exposed to the outside of the vehicle 10 (i.e., an environment outside the vehicle) and against which electromagnetic waves from the outside of the vehicle 10 impinge.” The electromagnetic waves include radio waves, visible light, and infrared light (infrared laser light).

Notably, the first sensor 101 includes a SoC (System on a chip). The SoC of the first sensor 101 detects (obtains) the degree of dirtiness of the sensor surface of the first sensor 101 (specifically, the “magnitude of attenuation of the infrared light due to dirt on the sensor surface” which will be described later), and transmits the detection result to the travel control ECU 114. Further, the SoC of the first sensor 101 can drive the first cleaning unit 106. During a period during which the SoC of the first sensor 101 receives a cleaning instruction from the travel control ECU 114, the SoC of the first sensor 101 cleans the sensor surface of the first sensor 101 by driving the first cleaning unit 106.

The recognition ECU 105 obtains successively the images captured by the first camera 103 and the second camera 104. The recognition ECU 105 can detect other vehicles and pedestrians in the images, while distinguishing them from other objects, by executing a known image processing on the obtained images. Further, the recognition ECU 105 can recognize road signs contained in the images as well as road markings, such as lines and symbols, drawn on road surfaces.

The first cleaning unit 106, the second cleaning unit 107, the third cleaning unit 108, and the fourth cleaning unit 109 are connected to an unillustrated cleaning liquid storage tank. Each of the first cleaning unit 106, the second cleaning unit 107, the third cleaning unit 108, and the fourth cleaning unit 109 is a cleaning liquid jetting apparatus (referred to also as a “cleaner”) which includes a pump and a nozzle (both of which are not shown) and which is configured to suck a cleaning liquid from the cleaning liquid storage tank by operating the pump and jet the cleaning liquid from the nozzle. No particular limitation is imposed on the structures of the pump and the nozzle, and conventionally known structures can be applied.

The first cleaning unit 106 is configured to jet the cleaning liquid against the sensor surface of the first sensor 101 when driven, thereby cleaning the sensor surface of the first sensor 101. The first cleaning unit 106 is connected to the first sensor 101 and is driven by the SoC of the first sensor 101.

The second cleaning unit 107 is configured to jet the cleaning liquid against the sensor surface of the second sensor 102 when driven, thereby cleaning the sensor surface of the second sensor 102. The third cleaning unit 108 is configured to jet the cleaning liquid against the sensor surface of the first camera 103 when driven, thereby cleaning the sensor surface of the first camera 103. The second cleaning unit 107 and the third cleaning unit 108 are connected to the travel control ECU 114 and are driven by the travel control ECU 114.

The fourth cleaning unit 109 is configured to jet the cleaning liquid against the sensor surface of the second camera 104 when driven, thereby cleaning the sensor surface of the second camera 104. The fourth cleaning unit 109 is connected to the vehicle control ECU 115 and is driven by the vehicle control ECU 115.

The cleaning switch 110 is an operation device which is operated by an occupant (for example, a driver) of the vehicle 10 so as to clean the sensor surface of the second camera 104. The ignition switch 111 is an operation device which is operated by the occupant of the vehicle 10 so as to supply electric power to various apparatuses and units mounted on the vehicle 10 and stop the supply of electric power.

The switch ECU 112 is connected to the cleaning switch 110 and the ignition switch 111. The switch ECU 112 detects the states of the switches connected thereto and executes controls in accordance with the detected states of the switches. Specifically, the switch ECU 112 determines whether or not the cleaning switch 110 has been operated so as to instruct the drive of the fourth cleaning unit 109. In the case where the cleaning switch 110 has been operated, the switch ECU 112 sends a cleaning instruction to the vehicle control ECU 115. When the vehicle control ECU 115 receives the cleaning instruction from the switch ECU 112, the vehicle control ECU 115 cleans the sensor surface of the second camera 104 by driving the fourth cleaning unit 109. In the case where the switch ECU 112 detects an operation of turning on the ignition switch 111, the switch ECU 112 starts the supply of electric power from a vehicle-mounted battery to various electric apparatuses and units mounted on the vehicle 10. In the case where the switch ECU 112 detects an operation of turning off the ignition switch 111, the switch ECU 112 stops the supply of electric power to the electric apparatuses and units.

Notably, the first cleaning unit 106, the second cleaning unit 107, the third cleaning unit 108, and the fourth cleaning unit 109 automatically operate under cleaning control executed by the travel control ECU 114 (namely, without requiring any operation by the occupant of the vehicle 10). Further, the fourth cleaning unit 109 operates also when the cleaning switch 110 is operated by the occupant.

The HMI (Human Machine Interface) 113 includes a display unit 116 capable of displaying images, and a sound output unit 117 capable of outputting sounds. The display unit 116 is configured to display an image (including figures, characters, and symbols) on the basis of a notification instruction transmitted from the travel control ECU 114. The display unit 116 can provide various pieces of information to the driver by displaying images. The display unit 116, which can display, for example, a two-dimensional image in full colors, can be configured by using a liquid crystal display, an organic EL display, a plasma display, or the like. The sound output unit 117 is configured to output a sound on the basis of the notification instruction transmitted from the travel control ECU 114.

The travel control ECU 114 executes the cleaning control for cleaning the sensor surfaces of the first sensor 101, the second sensor 102, the first camera 103, and the second camera 104. The travel control ECU 114 is connected to the second cleaning unit 107 and the third cleaning unit 108 and can drive these cleaning units. The travel control ECU 114 can transmit a cleaning instruction to the first sensor 101 via the Ethernet network and can transmit a cleaning instruction to the vehicle control ECU 115 via the CAN. The travel control ECU 114 is configured to obtain the travel distance of the vehicle 10. Specifically, the travel control ECU 114 computes the travel distance of the vehicle 10 on the basis of a travel time and a vehicle speed detected by an unillustrated vehicle speed sensor.

When the vehicle control ECU 115 receives a cleaning instruction from the travel control ECU 114, the vehicle control ECU 115 drives the fourth cleaning unit 109, thereby cleaning the sensor surface of the second camera 104. In addition, when the vehicle control ECU 115 receives a cleaning instruction from the switch ECU 112, the vehicle control ECU 115 drives the fourth cleaning unit 109, thereby cleaning the sensor surface of the second camera 104. Notably, in the case where the vehicle control ECU 115 receives cleaning instructions from both the travel control ECU 114 and the switch ECU 112, the vehicle control ECU 115 arbitrates between the cleaning instructions received from the travel control ECU 114 and the switch ECU 112. Specifically, the vehicle control ECU 115 drives the fourth cleaning unit 109 during both a period during which the vehicle control ECU 115 receives a cleaning instruction from the travel control ECU 114 and a period during which the vehicle control ECU 115 receives a cleaning instruction from the switch ECU 112.

### Cleaning Control

Next, the cleaning control for cleaning the sensor surfaces will be described. Since each of the first sensor 101 and the second sensor 102 is a LIDAR which utilizes infrared light, if the sensor surface becomes dirty, the attenuation of the infrared light due to dirt on the sensor surface becomes large, which may lead to deterioration of detection performance. Since each of the first camera 103 and the second camera 104 is a camera which photographs a scene outside the vehicle by using visible light, if the sensor surface becomes dirty, the dirt on the sensor surface may make it impossible to photograph the scene outside the vehicle or to obtain a clear image.

Therefore, the travel control ECU 114 determines whether or not an automatic cleaning condition showing that an automatic cleaning request is present for each sensor surface has been satisfied. The automatic cleaning condition is satisfied when each sensor surface has become dirty to an extent that requires cleaning (this will be described in detail later). In the case where the travel control ECU 114 determines that the automatic cleaning condition has been satisfied for a certain sensor surface (namely, an automatic cleaning request (or an automatic cleaning request signal) has been generated), in order to clean the certain sensor surface, the travel control ECU 114 activates, for a predetermined period of time T, the cleaning unit 106, 107, 108, or 109 corresponding to the certain sensor surface. Namely, the travel control ECU 114 generates, for the predetermined period of time T, a cleaning instruction to a cleaning unit which can clean the sensor surface for which the travel control ECU 114 has determined that the automatic cleaning condition has been satisfied, thereby causing that cleaning unit to perform the cleaning operation which uses a predetermined amount of the cleaning liquid. Such an operation of cleaning the sensor surface on the basis of the automatic cleaning request (operation of cleaning the sensor surface that is not based on an occupant's operation) may be referred to as “automatic cleaning operation” in some cases. Notably, the above-mentioned predetermined period of time T may be the same among the cleaning units 106, 107, 108, and 109 or differ among the cleaning units 106, 107, 108, and 109.

Incidentally, in the case where the travel environment of the vehicle 10 is an environment in which a certain sensor surface easily becomes dirty, the travel control ECU 114 causes one cleaning unit 106, 107, 108, or 109 corresponding to the certain sensor surface to operate frequently. Namely, in such an environment, the travel control ECU 114 frequently executes the automatic cleaning for the certain sensor surface. For example, in the case where the travel environment of the vehicle 10 is an environment in which the vehicle 10 is travelling on a muddy road while following another vehicle, the sensor surface of the first sensor 101 and/or the sensor surface of the first camera 103 are highly likely to become dirty frequently, and the cleaning unit 106 and/or the cleaning unit 108 corresponding to these sensor surfaces operate frequently. Therefore, the amount of use (consumption) of the cleaning liquid increases.

Also, there arises the case where, since the dirt on a certain sensor surface is stubborn, the dirt cannot be removed even when the cleaning liquid is jetted against that sensor surface. In such a case as well, the automatic cleaning condition for that sensor surface is satisfied continuously. Since the travel control ECU 114 continuously activates one cleaning unit 106, 107, 108, or 109 corresponding to that sensor surface even in such a case, the amount of the cleaning liquid used increases.

### Cleaning Prohibition Condition (First Particular Condition and Second Particular Condition)

In view of the above, the travel control ECU 114 determines, for each sensor surface (for each of the first sensor 101, the second sensor 102, the first camera 103, and the second camera 104), whether or not a cleaning prohibition condition has been satisfied. More specifically, the cleaning prohibition condition is satisfied when at least one of a first particular condition (which will be described later) and a second particular condition (which will be described later) is satisfied.

First particular condition: a condition determined beforehand such that the condition is satisfied when the travel environment of the vehicle 10 is an environment in which the sensor surface easily becomes dirty.

Second particular condition: a condition determined beforehand such that the condition is satisfied when the dirt on a sensor surface cannot be removed by jetting of the cleaning liquid by a cleaning unit (one of the cleaning units 106, 107, 108, and 109) corresponding to that sensor surface.

In the case where the travel control ECU 114 determines that at least one of the first particular condition and the second particular condition has been satisfied for a certain sensor surface, even when the automatic cleaning condition for that sensor surface is satisfied, the travel control ECU 114 does not activate the cleaning unit corresponding to that sensor surface (prohibits the cleaning operation). As a result, the amount of the cleaning liquid used is reduced. Notably, in the case where at least one of the first particular condition and the second particular condition has been satisfied for a certain sensor surface can be said that a cleaning prohibition condition for that sensor surface has been satisfied. The cleaning prohibition condition is a condition determined beforehand such that the condition is satisfied when the frequency of execution of the automatic cleaning operation exceeds a predetermined limit frequency.

Further, after the point when the travel control ECU 114 has determined that at least one of the first particular condition and the second particular condition has been satisfied for a certain sensor surface (namely, after the point when the travel control ECU 114 has determined that the cleaning prohibition condition for that sensor surface has been satisfied), the travel control ECU 114 determines whether or not a predetermined cancellation condition for that sensor surface has been satisfied. The cancellation condition will be described later. In the case where the travel control ECU 114 determines that the cancellation condition has been satisfied for that sensor surface, the travel control ECU 114 permits the operation (cleaning operation) of the cleaning unit corresponding to that sensor surface. Namely, in the case where, after having determined that the cancellation condition has been satisfied for a certain sensor surface, the travel control ECU 114 determines that the automatic cleaning condition for that sensor surface has been satisfied, the travel control ECU 114 activates the cleaning unit corresponding to that sensor surface.

### Sensor Surface Dirtiness Index Value

In the present embodiment, a parameter which represents the degree of dirtiness of each sensor surface (hereinafter may be referred as a “sensor surface dirtiness index value”) is used for determination as to whether or not the above-mentioned automatic cleaning condition has been satisfied. Namely, in the case where the sensor surface dirtiness index value of a certain sensor surface is equal to or greater than a first threshold (dirtiness determination threshold), the travel control ECU 114 determines that the automatic cleaning condition for that sensor surface has been satisfied. Notably, the first threshold may differ among the sensor surfaces.

Specifically, each of the sensor surface dirtiness index values of the first sensor 101 and the second sensor 102 is the magnitude of attenuation of infrared light due to dirt on the sensor surface, which is defined as follows.

Sensor surface dirtiness index value =(emission intensity of infrared light)/(incident intensity of infrared light)

The emission intensity of infrared light refers to the intensity of infrared light emitted toward the outside of the vehicle from the infrared light source of each of the first sensor 101 and the second sensor 102. The incident intensity of infrared light refers to the intensity of infrared light detected by each of the first sensor 101 and the second sensor 102.

In the case where the distribution of dirt on the sensor surface of a LIDAR such as the first sensor 101 or the second sensor 102 is uneven, the magnitude of attenuation of infrared light due to dirt may differ among positions on the sensor surface. Therefore, the magnitude of attenuation of infrared light may be obtained for each of a plurality of small regions obtained by dividing the sensor surface of the sensor composed of a LIDAR, and the average of the magnitudes of attenuation obtained for the small regions may be employed as the sensor surface dirtiness index value of the sensor composed of a LIDAR.

Each of the sensor surface dirtiness index values of the first camera 103 and the second camera 104 is the ratio of the area of a dirty region to the area of an image captured by each camera (captured image).

Sensor surface dirtiness index value=(the area of a dirty region of a captured image)/(the overall area of the captured image)

The dirty region of the captured image refers to a region whose brightness hardly changes over a predetermined period (time) or longer (namely, a region where a change in brightness is equal to or less than a threshold).

Notably, the recognition ECU 105 successively obtains images from the first camera 103 and the second camera 104 and computes the sensor surface dirtiness index values of the first camera 103 and the second camera 104 on the basis of the obtained images. The travel control ECU 114 obtains the computed sensor surface dirtiness index values from the recognition ECU 105. When the sensor surface dirtiness index value for a certain sensor surface is equal to or greater than a predetermined threshold (sensor surface dirtiness index value), the travel control ECU 114 determines that the degree of dirtiness of that sensor surface is equal to or greater than the first threshold, and determines that the automatic cleaning condition for that sensor surface has been satisfied. In this case as well, the first threshold may differ between the sensor surfaces.

For the determination as to whether the first particular condition has been satisfied for a certain sensor surface, the travel control ECU 114 uses the number of times N the cleaning unit corresponding to that sensor surface has been activated (the number of times N that cleaning unit has performed the automatic cleaning) while the vehicle 10 has traveled over a predetermined distance. In the case where the number of times N is equal to or greater than a second threshold (N2th), the travel control ECU 114 determines that the first particular condition for that sensor surface has been satisfied.

For the determination as to whether the second particular condition has been satisfied, the travel control ECU 114 uses the number of times the cleaning unit 106, 107, 108, or 109 has been caused to operate continuously (the number of times of continuous operation).

Here, the “continuous operation” will be described. It is supposed that tough dirt is present on a certain sensor surface, and that dirt cannot be removed by jetting of the cleaning liquid by the cleaning unit corresponding to that sensor surface. In this case, since the dirt on that sensor surface is not removed by a certain single cleaning operation (jetting of the cleaning liquid over the predetermined period of time T; in other words, cleaning operation using a predetermined amount of the cleaning liquid), in the determination as to whether or not the automatic cleaning condition is satisfied, which determination is made immediately after completion of that cleaning operation, the travel control ECU 114 determines that the automatic cleaning condition is satisfied. As a result, the travel control ECU 114 repeatedly activates the cleaning unit corresponding to that sensor surface. Namely, the travel control ECU 114 resumes the cleaning operation immediately after completion of the single-time cleaning operation. As described above, in the case where the automatic cleaning condition for a certain sensor surface is determined to be satisfied in “the determination as to whether or not the automatic cleaning condition is satisfied, which determination is made for the first time for that sensor surface after completion of the cleaning operation of the cleaning unit corresponding to that certain sensor surface, that cleaning unit is caused to operate repeatedly. Such operation is “continuous operation.” In the case where one of the cleaning units 106, 107, 108, and 109 has been caused to operate continuously (continuous operation) and the number of repetitions of the operation increases, it can be considered that the dirt on the sensor surface corresponding to that cleaning unit has not yet been removed. In view of the above, in the case where the number of times of the cleaning operation performed during a period during which one of the cleaning units 106, 107, 108, and 109 is caused to operate continuously (continuous operation) is equal to or greater than a third threshold, the travel control ECU 114 determines that the second particular condition has been satisfied for the sensor surface corresponding to the cleaning unit caused to operate continuously. In other words, the continuous operation is a phenomenon in which the period of time between a point when the automatic cleaning for a certain sensor surface by a corresponding cleaning unit ends and a point when the automatic cleaning by that cleaning unit is started again upon determination that the automatic cleaning condition for that sensor surface is newly satisfied is shorter than a predetermined threshold time. The number of times this phenomenon occurs continuously is the number of times of the continuous operation.

As described above, even in the case where the travel control ECU 114 determines that the automatic cleaning condition has been satisfied for a certain sensor surface, the travel control ECU 114 does not activate the cleaning unit corresponding to that certain sensor surface (prohibits the cleaning operation) if the travel control ECU 114 has determined that “at least one of the first particular condition and the second particular condition” for that sensor surface has been satisfied. As a result, the amount of the cleaning liquid used can be reduced. In other words, the possibility of wasteful consumption of the cleaning liquid can be reduced.

### Cancellation Condition

Next, the above-mentioned cancellation condition will be described. When the travel control ECU 114 determines that at least one of a first permission condition and a second permission condition (which will be described below) has been satisfied in a state in which the cleaning prohibition condition has been determined to be satisfied for a certain sensor surface, the travel control ECU 114 determines that the cancellation condition for that sensor surface has been satisfied.

First permission condition: a condition which is satisfied when the state of the ignition switch 111 is changed from ON to OFF.

Second permission condition: a condition which is satisfied when the sensor surface dirtiness degree (sensor surface dirtiness index value) of that sensor surface is continuously equal to or less than a “cancellation threshold less than the first threshold” for a predetermined time (watching time).

In the case where the state of the ignition switch 111 has been changed from ON to OFF, it is possible to consider that the occupant has an intention to get out of the vehicle 10 or has an intention not to cause the vehicle 10 to travel for a while. Accordingly, in the case where the ignition switch 111 is turned on again, there is a possibility that the environment in which the vehicle 10 is present has changed from the point when the ignition switch 111 was turned off. Namely, there is a possibility that the environment in which the vehicle 10 is present is not “the environment in which the sensor surface easily becomes dirty.” Further, there is a possibility that the occupant or another person has cleaned the sensor surface while the ignition switch 111 was in the OFF state. The above is the reason why the determination whether or not the first permission condition is satisfied is made. Further, in the case where, in a state in which the cleaning prohibition condition has been determined to be satisfied for a certain sensor surface, “the degree of dirtiness of that sensor surface has been determined to be continuously equal to or less than the cancellation threshold for the predetermined watching time,” it is possible to consider that the dirt on the sensor surface has been removed. The above is the reason why the determination whether or not the second permission condition is satisfied is made.

In order to realize the cleaning control as described above, for each of the cleaning units 106, 107, 108, and 109, the travel control ECU 114 determines an operation mode, which is either of a first mode and a second mode, and controls the operation of each cleaning unit in accordance with the operation mode determined for each cleaning unit.

More specifically, in the case where the operation mode for a certain cleaning unit is the first mode, the travel control ECU 114 permits the cleaning operation of that cleaning unit. Namely, in the case where the operation mode for the certain cleaning unit is the first mode, when the travel control ECU 114 determines that the automatic cleaning condition has been satisfied for a sensor surface corresponding to that cleaning unit, the travel control ECU 114 cleans that sensor surface (jets the cleaning liquid to that sensor surface) by using that cleaning unit.

In the case where the operation mode for a certain cleaning unit is the first mode, when the cleaning prohibition condition (i.e., at least one of the first particular condition and the second particular condition) is satisfied for a sensor surface corresponding to that cleaning unit, the travel control ECU 114 switches the operation mode for that cleaning unit from the first mode to the second mode.

In the case where the operation mode for a certain cleaning unit is the second mode, even when the travel control ECU 114 determines that the automatic cleaning condition has been satisfied for a sensor surface corresponding to that cleaning unit, the travel control ECU 114 does not clean the sensor surface by using that cleaning unit. Namely, the cleaning operation for that sensor surface is prohibited.

In the case where the operation mode for a certain cleaning unit is the second mode, when the cancellation condition (i.e., at least one of the first permission condition and the second permission condition) is satisfied for a sensor surface corresponding to that cleaning unit, the travel control ECU 114 switches the operation mode for that cleaning unit from the second mode to the first mode.

Notably, in the case where the operation mode for a certain cleaning unit is the second mode, when the occupant operates a switch for that cleaning unit (for example, the cleaning switch 110), the travel control ECU 114 may or may not cause that cleaning unit to perform the cleaning operation.

### Specific Operation

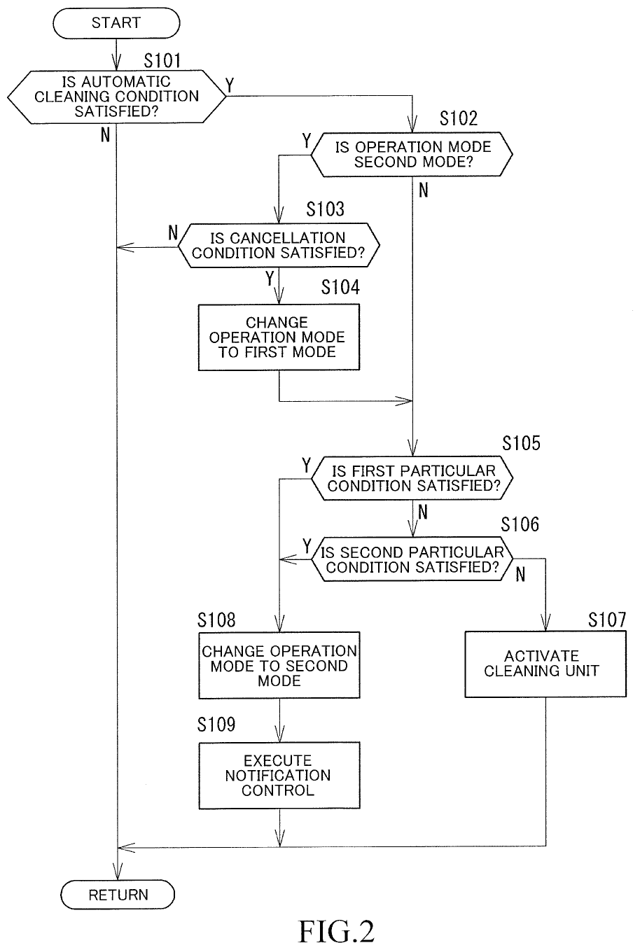

Next, specific operation of the travel control ECU 114 will be described. In the following description, the CPU of the travel control ECU 114 will be referred to simply as the “CPU.” Every time a predetermined period of time Δt1 elapses, the CPU executes a routine represented by a flowchart of FIG. 2.

Notably, the SoC of the first sensor 101 continuously executes the detection of the dirt on the sensor surface, and transmits “the sensor surface dirtiness index value of the first sensor 101,” which is the result of that detection, to the travel control ECU 114 every time a predetermined period of time Δt2 elapses. Further, the recognition ECU 105 continuously executes the detection of the dirt on the sensor surface of the first camera 103 and the dirt on the sensor surface of the second camera 104, and transmits “the sensor surface dirtiness index value of the first camera 103 and the sensor surface dirtiness index value of the second camera 104,” which are the results of that detection, to the travel control ECU 114 every time a predetermined period of time Δt3 elapses. In addition, every time a predetermined period of time Δt4 elapses, the CPU obtains “the sensor surface dirtiness index value of the second sensor 102” by separately executing an unillustrated routine.

Notably, the CPU executes the routine shown in FIG. 2 individually for a combination of the first sensor 101 and the first cleaning unit 106, a combination of the second sensor 102 and the second cleaning unit 107, a combination of the first camera 103 and the third cleaning unit 108, and a combination of the second camera 104 and the fourth cleaning unit 109. In the following, processing executed for the combination of the first sensor 101 and the first cleaning unit 106 will be described.

In step S101, the CPU determines, on the basis of the sensor surface dirtiness index value of the first sensor 101 obtained from the SoC of the first sensor 101, whether or not the sensor surface of the first sensor 101 satisfies the above-described automatic cleaning condition. In the case where the CPU determines that the sensor surface of the first sensor 101 does not satisfy the automatic cleaning condition, the CPU ends the current execution of this routine. Notably, in the case where the first cleaning unit 106 is operating (namely, jetting of the cleaning liquid against the sensor surface of the first sensor 101 continues) at the point when the CPU has proceeded to step S101, the CPU makes a “No” determination in step S101 without substantially determining whether or not the automatic cleaning condition is satisfied, and ends the current execution of this routine.

In contrast, in the case where the sensor surface of the first sensor 101 is dirty, the CPU determines that the automatic cleaning condition is satisfied. In this case, the CPU proceeds from step S101 to step S102 so as to determine whether or not the operation mode for the first cleaning unit 106 is the second mode. Notably, in an initialization routine executed by the CPU when the state of the ignition switch 111 is changed from OFF to ON, for reliable operation, the CPU initially sets the operation modes for all the cleaning units to the first mode.

Here, it is supposed that the travel environment is not an environment in which the sensor surface of the first sensor 101 easily becomes dirty (for example, the vehicle is traveling on a paved road in fine weather) and no tough dirt is present on the sensor surface of the first sensor 101.

In this case, since the above-described cleaning prohibition condition is not satisfied, the operation mode for the first cleaning unit 106 is maintained in the first mode. Therefore, the CPU makes a “No” determination in step S102 and proceeds to step S105 so as to determine whether or not the above-described first particular condition has been satisfied for the sensor surface of the first sensor 101.

Under the above-described supposition, the first particular condition is not satisfied for the sensor surface of the first sensor 101. Accordingly, the CPU makes a “No” determination in step S105 and proceeds to step S106 so as to determine whether or not the above-described second particular condition has been satisfied for the sensor surface of the first sensor 101. Under the above-described supposition, the second particular condition is not satisfied for the sensor surface of the first sensor 101. Accordingly, the CPU makes a “No” determination in step S106 and proceeds to step S107.

In step S107, the CPU performs a process of transmitting a cleaning instruction to the first sensor 101 over the predetermined period of time T. The first sensor 101 activates the first cleaning unit 106 during a period during which the first sensor 101 receives the cleaning instruction from the CPU. As a result, the cleaning liquid is jetted against the sensor surface of the first sensor 101, whereby the sensor surface of the first sensor 101 is cleaned.

Next, it is supposed that, although no tough dirt is present on the sensor surface of the first sensor 101, the travel environment has changed to an environment in which the sensor surface of the first sensor 101 easily becomes dirty. In this case, immediately after the travel environment has changed to the environment in which the sensor surface of the first sensor 101 easily becomes dirty, the CPU proceeds to step S107 through steps S101, S102, S105, and S106. Therefore, the frequency of cleaning of the sensor surface of the first sensor 101 increases.

When such a state continues, the first particular condition is satisfied for the sensor surface of the first sensor 101. In this case, when the CPU proceeds to step S105, the CPU makes a “Yes” determination in step S105, successively performs the process of steps S108 and S109, which will be described later, and ends the current execution of the present routine.

Step S108: the CPU changes the operation mode for the first cleaning unit 106 from the first mode to the second mode.

Step S109: the CPU executes notification control for transmitting a notification instruction to the HMI 113 so as to notify the occupant that the automatic cleaning by the first cleaning unit 106 has been prohibited (has stopped) (the first cleaning unit 106 is not activated automatically). Upon receipt of the notification instruction from the travel control ECU 114, the HMI 113 displays a message indicating that the automatic cleaning by the first cleaning unit 106 has been prohibited, and enunciates a message to that effect or outputs a predetermined warning sound. By virtue of such a notification control, it is possible to urge the occupant to clean the sensor surface manually. Further, it is possible to urge the occupant to move the vehicle 10 to an environment in which the sensor surface is less likely to become dirty. In addition, it is possible to prevent the occupant from feeling discomfort about the fact that the first cleaning unit has become unable to operate automatically.

In the case where the CPU proceeds from step S105 to step S108 as described above, since the CPU does not perform the process of step S107, the cleaning instruction is not transmitted to the first sensor 101. Therefore, in this case, the first cleaning unit 106 does not operate.

In the case where the operation mode for the first cleaning unit 106 has been changed from the first mode to the second mode, when the CPU makes a “Yes” determination in step S101 and proceeds to step S102, the CPU makes a “Yes” determination in step S102 and proceeds to step S103. In step S103, the CPU determines whether or not the above-described cancellation condition has been satisfied for the sensor surface of the first sensor 101. In the case where the cancellation condition is not satisfied, the CPU makes a “No” determination in step S103 and ends the current execution of this routine. In this case, the CPU maintains the operation mode for the first cleaning unit 106 in the second mode and does not transmit the cleaning instruction to the first sensor 101. Therefore, in the case where the operation mode for the first cleaning unit 106 is the second mode, the first cleaning unit 106 does not operate.

In the case where the cancellation condition for the sensor surface of the first sensor 101 is satisfied after that, when the CPU proceeds to step S103, the CPU makes a “Yes” determination in step S103 and proceeds to step S104. In step S104, the CPU changes the operation mode for the first cleaning unit 106 from the second mode to the first mode. Subsequently, the CPU proceeds to step S105. Therefore, until the first particular condition or the second particular condition is satisfied for the sensor surface of the first sensor 101, the CPU proceeds to step S107, so that the first cleaning unit 106 is activated.

Meanwhile, a process similar to that performed when the travel environment is the environment in which the sensor surface of the first sensor 101 easily becomes dirty is also performed when tough dirt adheres to the sensor surface of the first sensor 101 in a state in which the operation mode for the first cleaning unit 106 is the first mode. Namely, in this case, when the CPU proceeds to step S106, the CPU makes a “Yes” determination in step S106 and proceeds to steps S108 and S109. After that point, until the cancellation condition for the sensor surface of the first sensor 101 is satisfied, the operation mode for the first cleaning unit 106 is maintained in the second mode. As a result, the first cleaning unit 106 does not operate.

Notably, the operation of the CPU for each of the combination of the second sensor 102 and the second cleaning unit 107, the combination of the first camera 103 and the third cleaning unit 108, and the combination of the second camera 104 and the fourth cleaning unit 109 is approximately the same as the above-described operation. Therefore, the differences between the above-described operation of the CPU and the operation of the CPU for these combinations will be mainly described below.

For the combination of the second sensor 102 and the second cleaning unit 107, in step S101, the CPU determines whether or not the sensor surface of the second sensor satisfies the automatic cleaning condition, on the basis of the sensor surface dirtiness index value of the second sensor 102 separately calculated by the CPU itself. In step S107, the CPU cleans the sensor surface of the second sensor 102 by driving the second cleaning unit 107.

For the combination of the first camera 103 and the third cleaning unit 108, in step S101, the CPU obtains the sensor surface dirtiness index value of the first camera 103 from the recognition ECU 105 and determines, on the basis of the obtained index value, whether or not the sensor surface of the first camera 103 satisfies the automatic cleaning condition. In step S107, the CPU drives the third cleaning unit 108. As a result, the sensor surface of the first camera 103 is cleaned.

For the combination of the second camera 104 and the fourth cleaning unit 109, in step S101, the CPU obtains the sensor surface dirtiness index value of the second camera 104 from the recognition ECU 105 and determines, on the basis of the obtained index value, whether or not the sensor surface of the second camera 104 satisfies the automatic cleaning condition. In step S107, the CPU transmits the cleaning instruction to the vehicle control ECU 115. During a period during which the vehicle control ECU 115 receives the cleaning instruction from the CPU, the vehicle control ECU 115 drives the fourth cleaning unit 109. As a result, the sensor surface of the second camera 104 is cleaned.

The CPU executes the cleaning control as described above. Notably, the order of execution of steps S105 and S106 may be reversed. Further, the CPU may simultaneously perform in parallel the determination as to whether or not the first particular condition is satisfied and the determination as to whether or not the second particular condition is satisfied, and change the operation mode from the first mode to the second mode when the CPU determines that at least one of the first and second particular conditions is satisfied.

Further, the CPU may be configured to perform only one of the determination as to whether or not the first particular condition is satisfied and the determination as to whether or not the second particular condition is satisfied. For example, only the first particular condition may be employed as the cleaning prohibition condition. In this case, the CPU executes “a program obtained by eliminating step S106 from the program shown in FIG. 2 and configured in such a manner that, when the CPU makes a “No” determination in step S105, the CPU proceeds directly to step S107.” Similarly, only the second particular condition may be employed as the cleaning prohibition condition. In this case, the CPU executes “a program obtained by eliminating step S105 from the program shown in FIG. 2 and configured in such a manner that, when the CPU makes a “No” determination in step S102 and when the CPU ends the process of step S104, the CPU proceeds to step S106.”

Further, in the above-described routine, after the determination as to whether or not the automatic cleaning condition is satisfied, the CPU performs the determination as to whether or not the operation mode is the second mode and the determination as to whether or not the cancellation condition is satisfied. However, the order in which these determinations are performed is not limited to such an order. For example, step S101 of FIG. 2 may be located after step S102 and step S104. Namely, during the period during which the operation mode is the second mode, the CPU does not need to determine whether or not the automatic cleaning condition is satisfied.

Notably, the first threshold, the second threshold, the third threshold, and the above-described other thresholds are not limited to specific values and can be set appropriately.

The embodiment of the present invention has been described; however, the present invention is not limited to the above-described embodiment.

For example, in the above-described embodiment, the first sensor 101 and the second sensor 102 are LIDARs. However, the first sensor 101 and the second sensor 102 are not limited to LIDARs and may be millimeter-wave radars. Further, the first sensor 101 and the second sensor 102 may differ in type. Namely, one of the first sensor 101 and the second sensor 102 may be a LIDAR, and the other of the first sensor 101 and the second sensor 102 may be a millimeter-wave radar.

Further, although the configuration in which the first sensor 101 emits laser light toward the front side of the vehicle 10 and the second sensor 102 emits laser light toward the outside of the vehicle 10 in the vehicle width direction has been described, the sensor surface cleaning apparatus 100 of the present embodiment is not limited to such a configuration. The sensor surface cleaning apparatus 100 may be configured in such a manner that the first sensor 101 emits laser light toward the outside of the vehicle 10 in the vehicle width direction and the second sensor 102 emits laser light toward the front side of the vehicle 10. Alternatively, the sensor surface cleaning apparatus 100 may be configured in such a manner that the first sensor 101 and the second sensor 102 emit laser light toward the front side of the vehicle 10, or the first sensor 101 and the second sensor 102 emit laser light toward the outside of the vehicle 10 in the vehicle width direction. As described above, no limitation is imposed on the positions where the first sensor 101 and the second sensor 102 are provided, and on the direction in which laser light is emitted.

Similarly, although the configuration in which the first camera 103 photographs scenes ahead of the vehicle 10 and the second camera 104 photographs scenes behind the vehicle 10 has been described, the sensor surface cleaning apparatus 100 of the present embodiment is not limited to such a configuration. For example, the sensor surface cleaning apparatus 100 may be configured in such a manner that the first camera 103 photographs scenes behind the vehicle 10 and the second camera 104 photographs scenes ahead of the vehicle 10. Alternatively, the sensor surface cleaning apparatus 100 may be configured in such a manner that the first camera 103 and the second camera 104 photograph scenes on sides of the vehicle 10. As described above, no limitation is imposed on the positions where the first camera 103 and the second camera 104 are provided, and on the directions of scenes, with respect to the vehicle 10, which are photographed by the first camera 103 and the second camera 104.

Further, the sensor surface cleaning apparatus 100 of the embodiment includes the first sensor 101, the second sensor 102, the first camera 103, and the second camera 104 as sensor units. However, the sensor surface cleaning apparatus 100 is not limited to such a configuration. The sensor surface cleaning apparatus 100 may include, as sensor units, one to three of the first sensor 101, the second sensor 102, the first camera 103, and the second camera 104. Further, the sensor surface cleaning apparatus 100 may include a sensor unit(s) other than the first sensor 101, the second sensor 102, the first camera 103, and the second camera 104. Further, no limitation in the number of sensors or cameras is imposed on the first sensor 101, the second sensor 102, the first camera 103, and the second camera 104. Namely, the sensor surface cleaning apparatus 100 may include a plurality of the first sensors 101, a plurality of the second sensors 102, a plurality of the first cameras 103, a plurality of the second cameras 104.

The method for computing the sensor surface dirtiness index value of each of the sensors which are LIDARs (the first sensor 101 and the second sensor 102) is not limited to the above-described method. The sensor surface dirtiness index value of each sensor which is a LIDAR may be “the ratio of “”the area of a region where the ratio of emission intensity to incident intensity is equal to or greater than a predetermined threshold“” to “the area of the sensor surface (more specifically, the area of a region of the sensor surface, through which region infrared light detectable by the first sensor 101 or the second sensor 102 passes).” In this case, when this ratio serving as the sensor surface dirtiness index value is equal to or greater than a predetermined threshold, the travel control ECU 114 determines that the degree of dirtiness of the sensor surface is equal to or greater than the first threshold and thus determines that the automatic cleaning condition has been satisfied. In this case, the predetermined threshold which is compared with “the ratio of “the area of the region where the ratio of emission intensity to incident intensity is equal to or greater than the predetermined threshold”” to the area of the sensor surface” is the first threshold.

The method for computing the sensor surface dirtiness index value of each of the first camera 103 and the second camera 104 is not limited to the above-described method. When the sensor surface of the first camera 103 or the second camera 104 becomes dirty, a captured image contains a particular shadow representing a dirty region (in other words, the image contains a region which is lower in brightness than the remaining region of the image). Therefore, in the case where the captured image contains a shadow, the recognition ECU 105 can determine whether or not the shadow in the image is attributable to dirt by analyzing the pattern of the shadow by using AI (Artificial Intelligence). In the case where the recognition ECU 105 determines that this shadow is attributable to dirt, the recognition ECU 105 computes the ratio of the area of the shadow to the overall area of the image. The travel control ECU 114 determines whether or not this ratio is equal to or greater than a predetermined threshold. In the case where the travel control ECU 114 determines that this ratio is equal to or greater than the predetermined threshold, the travel control ECU 114 determines that the degree of dirtiness of the sensor surface is equal to or greater than the first threshold, and determines that the above-described automatic cleaning condition has been satisfied.

The “continuous operation” having been described associated with the above-described second particular condition is not limited to the above-described operation. For example, the continuous operation may be operation of causing the cleaning unit 106, 107, 108, or 109 to repeatedly operate upon determination that the automatic cleaning condition is satisfied before a predetermined time elapses after completion of the operation of the cleaning unit. Alternatively, the continuous operation may be operation of causing the cleaning unit 106, 107, 108, or 109 to operate a predetermined number of times or more per predetermined unit time.

The travel control ECU 114 may cause each cleaning unit to perform the automatic cleaning operation by transmitting a piece of information including the cleaning instruction directly to the cleaning unit. In this case, an unillustrated drive controller (or SoC) provided in the cleaning unit which has received the piece of information starts the operation of the cleaning unit and stops the operation of the cleaning unit after a predetermined amount of the cleaning liquid is jetted (the cleaning liquid is jetted over the predetermined period of time T).

Each of the first cleaning unit 106, the second cleaning unit 107, the third cleaning unit 108, and the fourth cleaning unit 109 is not required to jet the cleaning liquid against the corresponding sensor surface so long as the corresponding sensor surface can be cleaned by using the cleaning liquid. For example, each of these cleaning units may be an apparatus which wipes the sensor surface by using a separately provided wiping unit while causing the cleaning liquid to flow toward the sensor surface.

1. A sensor surface cleaning apparatus for a vehicle, comprising:
a sensor unit which produces output data by using an electromagnetic wave passing through a window portion whose one surface is exposed to an environment outside the vehicle as a sensor surface;
a cleaning unit configured to clean the sensor surface by using a cleaning liquid; and
a control unit which determines whether or not an automatic cleaning condition has been satisfied, the automatic cleaning condition being determined beforehand such that the automatic cleaning condition is satisfied when the sensor surface is dirty to an extent that requires cleaning, the control unit causing the cleaning unit to perform automatic cleaning operation which uses a predetermined amount of the cleaning liquid, when the control unit determines that the automatic cleaning condition has been satisfied, wherein
the control unit is configured to operate in accordance with an operation mode switchable between a first mode in which the control unit permits the automatic cleaning operation and a second mode in which the control unit does not permit the automatic cleaning operation; and
the control unit is configured in such a manner that, in a case where the operation mode is the first mode, the control unit determines whether or not a cleaning prohibition condition has been satisfied, the cleaning prohibition condition being determined beforehand such that the cleaning prohibition condition is satisfied when a frequency of execution of the automatic cleaning operation exceeds a limit frequency, and the control unit switches the operation mode to the second mode upon determination that the cleaning prohibition condition has been satisfied.

2. A sensor surface cleaning apparatus for a vehicle according to claim 1, wherein
the control unit is configured to obtain, on the basis of the output data from the sensor unit, a sensor surface dirtiness index value representing a degree of dirtiness of the sensor surface, to determine whether or not the sensor surface dirtiness index value is equal to or greater than a first threshold, and to determine that the automatic cleaning condition has been satisfied when the control unit determines that the sensor surface dirtiness index value is equal to or greater than the first threshold.

3. A sensor surface cleaning apparatus for a vehicle according to claim 2, wherein
the control unit is configured to determine that the cleaning prohibition condition has been satisfied when the control unit determines that a predetermined first particular condition showing that a travel environment of the vehicle is an environment in which the sensor surface easily becomes dirty has been satisfied.

4. A sensor surface cleaning apparatus for a vehicle according to claim 3, wherein
the control unit is configured to determine that the first particular condition has been satisfied when the number of times the control unit causes the cleaning unit to perform the automatic cleaning operation during a period of time during which the vehicle has traveled over a predetermined distance is equal to or greater than a second threshold.

5. A sensor surface cleaning apparatus for a vehicle according to claim 2, wherein
the control unit is configured to determine that the cleaning prohibition condition has been satisfied when the control unit determines that a predetermined second particular condition showing that dirt on the sensor surface cannot be removed by the cleaning liquid jetted by the cleaning unit has been satisfied.

6. A sensor surface cleaning apparatus for a vehicle according to claim 5, wherein
the control unit is configured to determine that the second particular condition has been satisfied when the number of times of continuous operation is equal to or greater than a third threshold, the number of times of continuous operation being the number of times of continuous occurrence of a phenomenon in which a time between a point when the automatic cleaning operation ends and a point when the automatic cleaning operation is started again upon new determination that the automatic cleaning condition has been satisfied is shorter than a predetermined threshold time.

7. A sensor surface cleaning apparatus for a vehicle according to claim 1, wherein
the control unit is configured to change the operation mode from the second mode to the first mode when an ignition switch of the vehicle is turned off in a period during which the operation mode is the second mode.

8. A sensor surface cleaning apparatus for a vehicle according to claim 2, wherein
the control unit is configured to change the operation mode from the second mode to the first mode when the control unit determines that the sensor surface dirtiness index value is continuously equal to or less than a cancellation threshold less than the first threshold for a predetermined time in a period during which the operation mode is the second mode.

9. A sensor surface cleaning apparatus for a vehicle according to claim 1, wherein
the control unit is configured in such a manner that, in the case where the control unit has changed the operation mode from the first mode to the second mode, the control unit executes notification control of notifying an occupant of the vehicle that the automatic cleaning operation is not performed.
